(19) United States
(12) Patent Application Publication
(10) Pub. No.: US 2020/0152145 A1
(43) Pub. Date: May 14, 2020

(54) CIRCUIT AND METHOD FOR DRIVING DISPLAY PANEL

(71) Applicant: HKC CORPORATION LIMITED, Shenzhen City, Guangdong (CN)

(72) Inventor: Huailiang HE, Guangdong (CN)

(21) Appl. No.: 15/739,240

(22) PCT Filed: Sep. 4, 2017
(86) PCT No.: PCT/CN2017/100332

§ 371 Date: Dec. 22, 2017

(30) Foreign Application Priority Data
Aug. 28, 2017 (CN) 201710752452.9

(51) Int. Cl. G09G 3/36

(52) U.S. Cl. CPC G09G 3/3614; G09G 2320/0233; G09G 3/3696; G09G 3/3677

(57) ABSTRACT

A method for driving a display panel includes: a plurality of data lines; a plurality of scanning lines, disposed crossing the data lines to define a plurality of pixel areas; a plurality of pixel units, disposed in the pixel areas, and separately electrically coupled to the data lines and the scanning lines; in a first scanning period, applying a first opening voltage to the pixel unit on a scanning line in a (2n−1)^{th} row; and in a second scanning period, applying a second opening voltage to the pixel unit on a scanning lines in a 2n^{th} row, where the scanning line in the (2n−1)^{th} row and the scanning line in the adjacent 2n^{th} row are coupled to a same data line, and n is a positive number; and a value of the first opening voltage is different from a value of the second opening voltage.

### BACKGROUND

### Technical Field

This application relates to the display field, to a pixel circuit and a related driving method, and in particular, to a circuit and method for driving a display panel.

### Related Art

A liquid crystal display apparatus displays an image by means of electrical properties and optical properties of liquid crystals. The liquid crystals have anisotropy. For example, the liquid crystals have different refractive indexes and dielectric constants between main shafts and secondary shafts of molecules. Molecular arrangement and optical properties of the liquid crystals may be easily adjusted. By changing the arrangement direction of liquid crystal molecules according to the magnitude of an electric field, the liquid crystal display apparatus adjusts the transmittance of light penetrating through a polarizer, to display an image.

The liquid crystal display apparatus includes a liquid crystal panel and a drive circuit. In the liquid crystal panel, a plurality of pixels is arranged in a matrix form. The drive circuit includes a gate driver used to drive scanning lines of the liquid crystal panel and a data driver used to drive data lines of the liquid crystal panel. To reduce costs of the liquid crystal display apparatus, reducing the quantity of output channels of the data driver by reducing the quantity of the data lines while maintaining the resolution of the liquid crystal panel has been considered.

With respect to a double rate driving (DRD) liquid crystal display apparatus, also referred to as a semi-source driving liquid crystal display apparatus, or a triple rate driving (TRD) liquid crystal display apparatus provided in recent years, two or three horizontally adjacent sub-pixels are connected to a single data line, and are sequentially driven by different scanning lines, so that upon comparison, the quantity of data lines and the quantity of output channels of a data driver can be reduced to half or one third the quantity of the data lines and the quantity of the output channels of the existing liquid crystal display apparatus.

The TRD-type liquid crystal display apparatus can reduce data lines and output channels of a data driver by larger quantities than the DRD-type liquid crystal display apparatus can, and therefore advantageously implementing low manufacturing costs. However, a DRD design can reduce the quantity of the data lines by half, and reduce a quantity of used printed circuit boards, thereby reducing costs. However, such a practice brings a problem of bright and dark lines during low gray scale display, and affects the product quality. Therefore, a new technology is urgently needed to resolve related problems.

### SUMMARY

To resolve the foregoing technical problem, an objective of this application is to provide a circuit and method for driving a display panel. According to this application, by providing different opening voltages to different scanning lines, the problem of low gray scale bright and dark lines caused by semi-source driving can be eliminated, thereby improving the display picture quality of the display panel.

The objective of this application is achieved and the technical problem of this application is resolved by using the following technical solutions. A method for driving a display panel provided according to this application includes: a plurality of data lines; a plurality of scanning lines, disposed crossing the data lines to define a plurality of pixel areas; a plurality of pixel units, disposed in the pixel areas, and separately electrically coupled to the data lines and the scanning lines; and the method comprises: in a first scanning period, applying a first opening voltage to the pixel unit on a scanning line in a (2n−1)^{th} row; and in a second scanning period, applying a second opening voltage to the pixel unit on a scanning line in a 2n^{th} row, wherein the scanning line in the (2n−1)^{th} row and the scanning line in the adjacent 2 n^{th} row are coupled to a same data line, and n is a positive number, and a value of the first opening voltage is different from a value of the second opening voltage.

In an embodiment of this application, the first opening voltage is greater than the second opening voltage.

In an embodiment of this application, on a same data line, a polarity of a pixel unit on the scanning line in the (2n−1)^{th} row is the same as a polarity of a pixel unit on the scanning line in the 2n^{th} row.

In an embodiment of this application, on a same data line, a polarity of a pixel unit on the scanning line in the (2n−1)^{th} row is different from a polarity of a pixel unit on a scanning line in a (2n+1)^{th} row, and a polarity of a pixel unit on a scanning line in a (2n−2)^{th} row is different from a polarity of a pixel unit on the scanning line in the 2n^{th} row.

In an embodiment of this application, on a same scanning line, polarities of adjacent pixel units are different.

In an embodiment of this application, polarities of a same pixel unit in adjacent two frames of images are different.

In an embodiment of this application, the first opening voltage and the second opening voltage enable a pixel unit in an n^{th} row after polarity inversion to output a same scanning voltage.

The objective of this application may further be achieved and the technical problem of this application may further be resolved by using the following technical solution.

Another objective of this application is to provide a circuit for driving a display panel, wherein the display panel comprises: a plurality of data lines; a plurality of scanning lines, disposed crossing the data lines to define a plurality of pixel areas; and a plurality of pixel units, disposed in the pixel areas, and separately electrically coupled to the data lines and the scanning lines, wherein a scanning line in a (2n−1)^{th} row and a scanning line in an adjacent 2n^{th} row are coupled to a same data line, and n is a positive number. Polarities of two pixel units on the scanning line in the (2n−1)^{th} row and the scanning line in the 2n^{th} row are the same, the two scanning lines being coupled to the same data line. The scanning line in the (2n−1)^{th} row has a first opening voltage, the scanning line in the 2n^{th} row has a second opening voltage, and the first opening voltage is greater than the second opening voltage.

In an embodiment of this application, polarities of adjacent pixel units coupled to a same scanning line are different.

In an embodiment of this application, on a same data line, a polarity of a pixel unit on the scanning line in the (2n−1)^{th} row is different from a polarity of a pixel unit on a scanning line in a (2n+1)^{th} row, and a polarity of a pixel unit on a scanning line in a (2n−2)^{th} row is different from a polarity of a pixel unit on the scanning line in the 2n^{th} row. Polarities of a same pixel unit in adjacent two frames of images are different.

In an embodiment of this application, polarities of a same pixel unit in adjacent two frames of images are different.

In an embodiment of this application, the first opening voltage and the second opening voltage enable a pixel unit in an n^{th} row after polarity inversion to output a same scanning voltage.

Still another objective of this application is a method for driving a display panel, wherein the display panel comprises: a plurality of data lines; a plurality of scanning lines, disposed crossing the data lines to define a plurality of pixel areas; a plurality of pixel units, disposed in the pixel areas, and separately electrically coupled to the data lines and the scanning lines; and the method comprises: in a first scanning period, applying a first opening voltage to a pixel unit on a scanning line in a (2n−1)^{th} row; and in a second scanning period, applying a second opening voltage to a pixel unit on a scanning line in a 2n^{th} row, wherein the scanning line in the (2n−11)^{th} row and the scanning line in the adjacent 2n^{th} row are coupled to a same data line, and n is a positive number, a value of the first opening voltage is different from a value of the second opening voltage, and the first opening voltage is greater than the second opening voltage; and the first opening voltage and the second opening voltage enable an pixel unit in an n^{th} row after polarity inversion to output a same scanning voltage.

According to this application, by providing different opening voltages to different scanning lines, the problem of low gray scale bright and dark lines caused by a semi-source driving can be eliminated, thereby improving the display picture quality of the display panel.

### BRIEF DESCRIPTION OF THE DRAWINGS

FIG. 1 is a partial schematic diagram of an exemplary display panel;

FIG. 2 is a schematic diagram of exemplary charging of scanning lines;

FIG. 3 is a schematic diagram of exemplary opening voltages of scanning lines;

FIG. 4 is a schematic diagram of opening voltages of scanning lines according to an embodiment of this application;

FIG. 5 is a schematic diagram of a display panel according to an embodiment of this application; and

FIG. 6 is a schematic diagram of modules of a display apparatus according to an embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical means used in this application to achieve the application objective and effects thereof, specific implementations, structures, features, and effects of a circuit and method for driving a display panel provided according to this application are described in detail below with reference to the drawings and preferred embodiments.

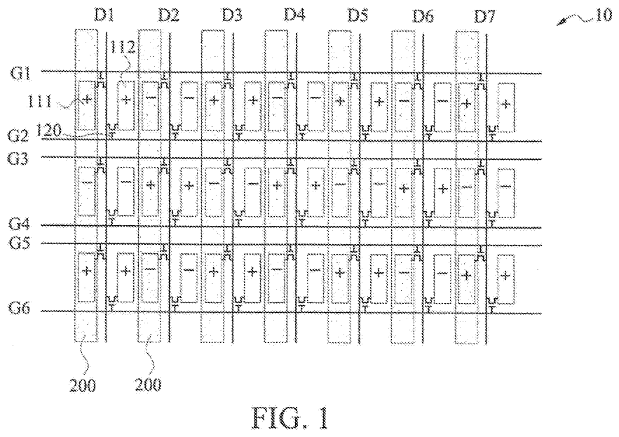

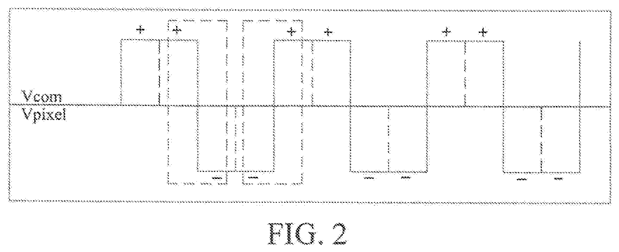

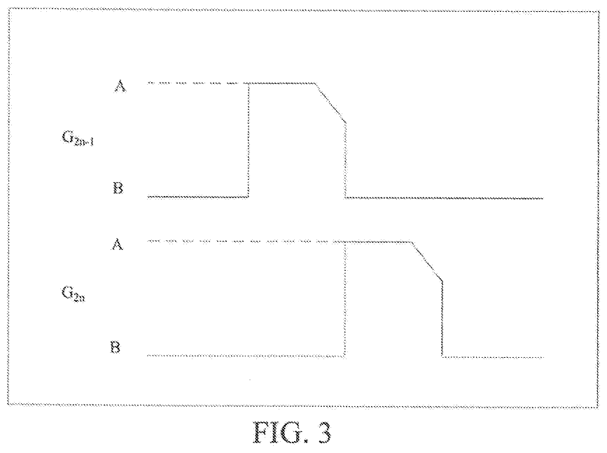

FIG. 1 is a partial schematic diagram of an exemplary display panel. FIG. 2 is a schematic diagram of exemplary charging of scanning lines. FIG. 3 is a schematic diagram of exemplary opening voltages of scanning lines. According to FIG. 1, FIG. 2, and FIG. 3, an exemplary display panel 10 includes: a substrate (not shown in the figure); a plurality of data lines (D1 to D7), disposed on the substrate; a plurality of scanning lines (G1 to G6), disposed on the substrate, and disposed crossing the data lines to define a plurality of pixel areas; a plurality of pixel units (111, 112), disposed on the substrate, and located in the pixel areas, where the pixel units (111, 112) are separately electrically coupled to the data lines and the scanning lines; and a plurality of active switches 120, separately coupled to the corresponding data lines, scanning lines, and pixel units (111, 112). A scanning line in a (2n−1)^{th} row and a scanning line in an adjacent 2n^{th} row are coupled to a same data line, and n is a positive number. The circuit design is also referred to as a semi-source drive circuit. Pixel voltage configuration of a circuit of this type may be performed in a two-column inversion manner (as shown in FIG. 2). During charging, there is no cross voltage or there is a small cross voltage when scanning opening voltages of the pixel units (111, 112) on the panel move from a positive polarity to a positive polarity or from a negative polarity to a negative polarity. In this case, charging of the pixel units (111, 112) is relatively saturated, and finally presented parameters such as the panel brightness can reach an expected display effect.

However, when the scanning opening voltages of the pixel units (111, 112) on the panel move from a positive polarity to a negative polarity or from a negative polarity to a positive polarity, that is, during polarity inversion, a cross voltage of the pixel units 111 on the display panel is relatively large. A “grade climbing” time for voltage increase or decrease is needed before voltage switching. Moreover, the scanning opening voltages (A-B) of odd-numbered and even-numbered pixel units (111, 112) are the same. In this case, charging of the pixel units 111 is not saturated relative to charging of the pixel units 112. That is, display parameters such as the brightness of the pixel units 111 cannot reach the expected effect. Finally, display on the display panel 10 is dark, as shown in a pixel display area 200. Consequently, the problem of bright and dark lines is caused, and the quality and the display effect of the display panel 10 are affected.

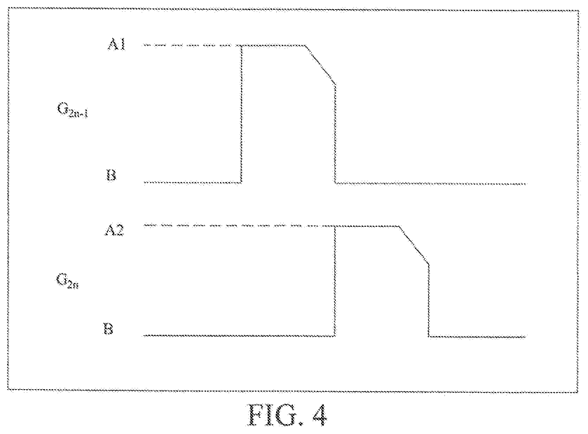

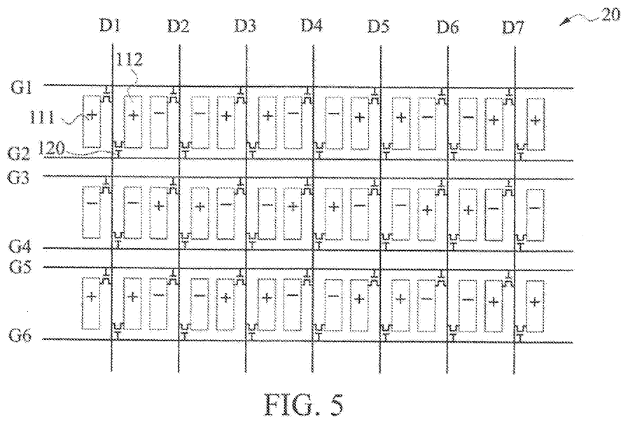

FIG. 4 is a schematic diagram of opening voltages of scanning lines according to an embodiment of this application. FIG. 5 is a schematic diagram of a display panel according to an embodiment of this application. Refer to both FIG. 4 and FIG. 5. In an embodiment of this application, a display panel 20 includes a drive circuit, including: a substrate (not shown in the figure); a plurality of data lines (D1 to D7), disposed on the substrate; a plurality of scanning lines (G1 to G6), disposed on the substrate, and disposed crossing the data lines to define a plurality of pixel areas; a plurality of pixel units (111, 112), disposed on the substrate, and located in the pixel areas, where the pixel units (111, 112) are separately electrically coupled to the data lines and the scanning lines; and a plurality of active switches 120, separately coupled to the corresponding data lines, scanning lines, and pixel units (111, 112). A scanning line in a (2n−1)^{th} row and a scanning line in a 2n^{th} row are coupled to a same data line, and n is a positive number. The scanning line in the (2n−1)^{th} row has a first opening voltage (A1-B), and the scanning line in the 2n^{th} row has a second opening voltage (A2-B).

In an embodiment of this application, the first opening voltage (A1-B) is greater than the second opening voltage (A2-B), to overcome a voltage difference caused by polarity inversion and line layout of the display panel (for example, related factors such as line impedance).

In an embodiment of this application, polarities of adjacent pixel units 111 or 112 coupled to a same scanning line are different.

Referring to FIG. 4 and FIG. 5 again, in an embodiment of this application, a method for driving a display panel includes: a substrate (not shown in the figure); a plurality of data lines (D1 to D7), disposed on the substrate; a plurality of scanning lines (G1 to G6), disposed on the substrate, and disposed crossing the data lines to define a plurality of pixel areas; a plurality of pixel units (111, 112), disposed on the substrate, and located in the pixel areas, where the pixel units (111, 112) are separately electrically coupled to the data lines and the scanning lines; and a plurality of active switches 120, separately coupled to the corresponding data lines, scanning lines, and pixel units (111, 112). In a first scanning period, a first opening voltage (A1-B) is applied to the pixel units 111 on scanning lines in (2n−1)^{th} rows. In a second scanning period, a second opening voltage (A2-B) is applied to the pixel units 112 on scanning lines in 2n^{th} rows. A scanning line in a (2n−1)^{th} row and a scanning line in an adjacent 2n^{th} row are coupled to a same data line, and n is a positive number.

In an embodiment of this application, the pixel units 111 are pixel units coupled to odd-numbered scanning lines (that is, the scanning lines in the (2n−1)^{th} rows). The pixel units 112 are pixel units coupled to even-numbered scanning lines (that is, the scanning lines in the 2n^{th} rows).

In an embodiment of this application, on a same data line, the polarity of the pixel unit 111 on the scanning line in the (2n−11)^{th} row is the same as the polarity of the pixel unit 112 on the scanning line in the 2n^{th} h row.

In an embodiment of this application, on a same data line, the polarity of the pixel unit 111 on the scanning line in the (2n−1)^{th} row is different from the polarity of the pixel unit 111 on a scanning line in a (2n+1)^{th} row, and the polarity of the pixel unit 112 on a scanning line in a (2n−2)^{th} row is different from the polarity of the pixel unit 112 on the scanning line in the 2n^{th} row.

In an embodiment of this application, on a same scanning line, the polarities of adjacent pixel units 111 or 112 are different.

In an embodiment of this application, in display images presented by the display panel, the polarities of the same pixel unit (111, 112) in adjacent two frames of images are different. That is, the pixel unit 111 needs to pass a “grade climbing” time for voltage increase or decrease for polarity inversion.

In an embodiment of this application, the value of the first opening voltage (A1-B) is different from the value of the second opening voltage (A2-B). In addition, the first opening voltage (A1-B) is greater than the second opening voltage (A2-B).

In an embodiment of this application, the first opening voltage (A1-B) and the second opening voltage (A2-B) enable the pixel unit 111 in the (2n−1)^{th} row after polarity inversion to output a scanning voltage the same or similar to a scanning voltage output by the pixel unit 112 (there is a voltage difference due to the yield of a manufacturing process and the wire layout, but the voltage difference is within a controllable range, and it is particularly declared that the display effect is not affected). The design can overcome the voltage difference (or a “grade climbing” time), caused by polarity inversion and the wire layout of the display panel, between the pixel unit 111 and the pixel unit 112, so that related display parameters can reach an expected effect, and a finally presented display image does not have a problem of bright and dark lines in an exemplary display panel.

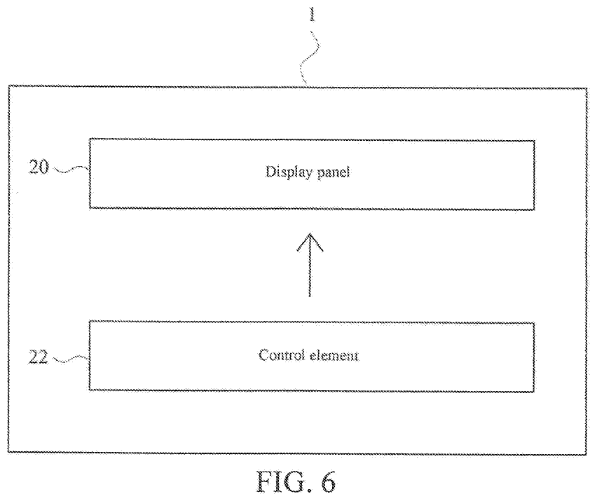

FIG. 6 is a schematic diagram of modules of a display apparatus according to an embodiment of this application. Referring to FIG. 4 to FIG. 6, in an embodiment, a display apparatus 1 includes a control element 22, and also includes the display panel 20, and the drive circuit and the drive method in the foregoing embodiments. The display panel may be, for example, a quantum dots light-emitting diode (QLED) panel, an organic light-emitting diode (OLED) panel, or a liquid crystal display (LCD) panel. However, this application is not limited thereto.

In some embodiments, the first opening voltage (A1-B) and the second opening voltage (A2-B) are provided by the control element 22, to overcome the problem of bright and dark lines.

According to this application, by providing different opening voltages (A1-B, A2-B) to different scanning lines, the problem of bright and dark lines, under low gray scale display and caused by a voltage difference, of semi-source driving can be eliminated, thereby improving the display picture quality of the display panel and the display apparatus.

The wordings such as “in some embodiments” and “in various embodiments” are repeatedly used. They usually do not refer to a same embodiment; but they may refer to a same embodiment. The words, such as “comprise”, “have”, and “include”, are synonyms, unless other meanings are indicated in the context thereof.

The foregoing descriptions are merely embodiments of this application, and are not intended to limit this application in any form. Although this application has been disclosed above through the preferred embodiments, the embodiments are not intended to limit this application. Any person skilled in the art can make some variations or modifications, namely, equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A method for driving a display panel, wherein the display panel comprises: a plurality of data lines; a plurality of scanning lines, disposed crossing the data lines to define a plurality of pixel areas; a plurality of pixel units, disposed in the pixel areas, and separately electrically coupled to the data lines and the scanning lines;
and the method comprises:
in a first scanning period, applying a first opening voltage to the pixel unit on a scanning line in a (2n−1)^{th} row; and
in a second scanning period, applying a second opening voltage to the pixel unit on a scanning lines in a 2n^{th} row, wherein
the scanning line in the (2n−1)^{th} row and the scanning line in the adjacent 2n^{th} row are coupled to a same data line, and n is a positive number; and
a value of the first opening voltage is different from a value of the second opening voltage.

2. The method for driving a display panel according to claim 1, wherein the first opening voltage is greater than the second opening voltage.

3. The method for driving a display panel according to claim 1, wherein on a same data line, a polarity of a pixel unit on the scanning line in the (2n−1)^{th} h row is the same as a polarity of a pixel unit on the scanning line in the 2n^{th} row.

4. The method for driving a display panel according to claim 1, wherein on a same data line, a polarity of a pixel unit on the scanning line in the (2n−1)^{th} row is different from a polarity of a pixel unit on a scanning line in a (2n+1)^{th} row.

5. The method for driving a display panel according to claim 1, wherein on a same data line, a polarity of a pixel unit on a scanning line in a (2n−2)^{th} row is different from a polarity of a pixel unit on the scanning line in the 2n^{th} row.

6. The method for driving a display panel according to claim 1, wherein on a same scanning line, polarities of adjacent pixel units are different.

7. The method for driving a display panel according to claim 1, wherein polarities of a same pixel unit in adjacent two frames of images are different.

8. The method for driving a display panel according to claim 7, wherein the first opening voltage and the second opening voltage enable the pixel unit in an n^{th} row after polarity inversion to output a same scanning voltage.

9. A circuit for driving a display panel, wherein the display panel comprises:
a plurality of data lines;
a plurality of scanning lines, disposed crossing the data lines to define a plurality of pixel areas; and
a plurality of pixel units, disposed in the pixel areas, and separately electrically coupled to the data lines and the scanning lines, wherein
a scanning line in a (2n−1)^{th} row and a scanning line in an adjacent 2n^{th} row are coupled to a same data line, and n is a positive number;
polarities of two pixel units on the scanning line in the (2n−1)^{th} row and the scanning line in the 2n^{th} row are the same, the two scanning lines being coupled to the same data line; and
the scanning line in the (2n−1)^{th} row has a first opening voltage, the scanning line in the 2n^{th} row has a second opening voltage, and the first opening voltage is greater than the second opening voltage.

10. The circuit for driving a display panel according to claim 9, polarities of adjacent pixel units coupled to a same scanning line are different.

11. The circuit for driving a display panel according to claim 9, wherein on a same data line, a polarity of a pixel unit on the scanning line in the (2n−1)^{th} row is different from a polarity of a pixel unit on a scanning line in a (2n+1)^{th} row.

12. The circuit for driving a display panel according to claim 9, wherein on a same data line, a polarity of a pixel unit on a scanning line in a (2n−2)^{th} row is different from a polarity of a pixel unit on the scanning line in the 2n^{th} row.

13. The circuit for driving a display panel according to claim 9, wherein polarities of a same pixel unit in adjacent two frames of images are different.

14. The circuit for driving a display panel according to claim 13, wherein the first opening voltage and the second opening voltage enable the pixel unit in an n^{th} row after polarity inversion to output a same scanning voltage.

15. A method for driving a display panel, wherein the display panel comprises:
a plurality of data lines;
a plurality of scanning lines, disposed crossing the data lines to define a plurality of pixel areas;
a plurality of pixel units, disposed in the pixel areas, and separately electrically coupled to the data lines and the scanning lines;
and the method comprises:
in a first scanning period, applying a first opening voltage to the pixel unit on a scanning line in a (2n−1)^{th} row; and
in a second scanning period, applying a second opening voltage to the pixel unit on a scanning line in a 2n^{th} row, wherein
the scanning line in the (2n−1)^{th} row and the scanning line in the adjacent 2n^{th} row are coupled to a same data line, and n is a positive number;
a value of the first opening voltage is different from a value of the second opening voltage, and the first opening voltage is greater than the second opening voltage; and
the first opening voltage and the second opening voltage enable the pixel unit in an n^{th} row after polarity inversion to output a same scanning voltage.
